(19) United States
(12) Patent Application Publication
(10) Pub. No.: US 2025/0140222 A1
(43) Pub. Date: May 1, 2025

(54) GESTURE-BASED AUDIO SYNTHESIZER CONTROLLER

(71) Applicant: Little People Big Noise Limited, Canterbury Kent (GB)

(72) Inventor: Kelcey Robert Swain, Keele Staffordshire (GB)

(21) Appl. No.: 18/686,641

(22) PCT Filed: Aug. 25, 2022
(86) PCT No.: PCT/EP2022/073683

§ 371 Date: Feb. 26, 2024

(30) Foreign Application Priority Data
Aug. 27, 2021 (GB) 2112321.1

(51) Int. Cl. G10H 1/00; G01C 21/16; G10H 7/00

(52) U.S. Cl. CPC G10H 1/0008; G01C 21/16; G10H 7/002; G10H 2220/185; G10H 2220/365; G10H 2220/391; G10H 2220/395

(57) ABSTRACT

A method of generating audio synthesizer control signals, the method comprising: receiving at a processing component, from a multi-dimensional orientation sensor of a controller device, inputs denoting sensed changes in orientation of the control device in first and second angular dimensions; processing the inputs to generate audio synthesizer control signals; and outputting the audio synthesizer control signals to an audio synthesizer; wherein the audio synthesizer control signals cause a first audible characteristic of the audio signal to be varied responsive to changes in orientation in the first angular dimension, and a second audible characteristic of the audio signal to be varied responsive to changes in orientation of the control device in the second angular dimension.

### TECHNICAL FIELD

The present disclosure pertains to a gesture-based audio synthesizer controller, and to methods and computer programs for implementing functionality of the same.

### BACKGROUND

In the field of music technology, audio synthesizers have been developed over many years. Such synthesizers include, for example, samplers, additive/subtractive synthesizers, frequency-modulation/amplitude-modulation synthesizers, granular synthesizers, hybrid synthesizers etc. Traditionally, synthesizer controllers have mainly been designed to approximate traditional piano keyboards. A physical keyboard controller may be integrated within an audio synthesizer device, or provided as a standalone controller that outputs control signals to an external synthesizer using an appropriate message format (such as MIDI). Drum pads and push-button controller have also been used, particularly as a means of triggering drum sounds or sampled audio. Such controllers are generally designed to be played in a similar manner to a piano or percussion instrument.

Interface devices are available which can attach to a stringed instrument, such as a guitar, violin or cello, and convert an audio signal recorded from the instrument to synthesizer control signals. Such devices typically take the form of “MIDI pickups” which convert captured audio to MIDI control messages. In principle, such devices allow, e.g. a guitarist, violinist or cellist, to “play” an audio synthesizer via their instrument, without requiring a traditional controller (such as a keyboard or drum pad). These relatively niche devices are expensive and do not always perform reliably. Such devices can also only operate in conjunction with an acoustic or electric instrument capable of producing sound, such as an acoustic or electric guitar, violin, cello etc.

Recent years have seen a wider range of control modalities for audio synthesizers. Touch-screen devices, and tablet devices in particular, have opened up greater possibility for audio synthesis based on touch gestures. However, touchscreen is a fairly limited modality that does not allow for much in the way of musical expression.

Synthesizer control based on “free space” gestures has seen some limited attention. One early example is the theremin, comprised of two antennas for sensing a player's hand position. More recent, imaging techniques may be used to track a user's motion and generate audio signals in response. Such techniques require one or multiple sensors (e.g. antennas, optical or infrared cameras etc.) to be appropriately set up, and are limited by the range and, in some cases, the directionality of the sensors. Moreover, the lack of any tactile control may be a barrier to musical expression.

### SUMMARY

One aim herein is to provide a low-cost audio synthesizer controller that provides one or more free-space gesture control modalities for an audio synthesizer. An audio synthesizer may be implemented in hardware, software or a combination thereof, and may be implemented within the controller itself or externally to it. The controller takes the form of a handheld device that can be manipulated to control different facets of audio signal generation in a tactile and musically expressive manner. The response of the device may be designed to mirror one or more traditional instruments. Skilled musicians can therefore utilize the device with ease, as their existing skills and techniques are readily transferrable. Conversely, the device may be used as a learning aid for beginners or less experienced musicians, as a way to develop skills and techniques that are transferrable to other instruments.

The controller device includes an internal orientation sensor, such as a multi-axis inertial measurement unit (IMU). In preferred embodiments, the orientation sensor comprises a three-axis accelerometer, three-axis gyroscope and three-axis magnetometer providing 9-DOF measurements. Note, the term orientation sensor herein includes a device or system with multiple individual sensor components (such as two or more of a multi-axis gyroscope, accelerometer and magnetometer) capable or measuring orientation and/or rotational motion (velocity, acceleration etc.) individually or in combination. The device is “self-localizing” in that measurements taken by the internal sensor are entirely sufficient for implementing the gesture-based control, without the use of external cameras or other external sensors.

A first aspect herein provides a method of generating audio synthesizer control signals, the method comprising: receiving at a processing component, from a multi-dimensional orientation sensor of a controller device, inputs denoting sensed changes in orientation of the control device in first and second angular dimensions; processing the inputs to generate audio synthesizer control signals; and outputting the audio synthesizer control signals to an audio synthesizer; wherein the audio synthesizer control signals cause a first audible characteristic of the audio signal to be varied responsive to changes in orientation in the first angular dimension, and a second audible characteristic of the audio signal to be varied responsive to changes in orientation of the control device in the second angular dimension.

This first aspect provides a “bowing” modality, that mirrors paying techniques associated with bowed instruments via free-space gesture control. For example, in some embodiments, the second audible characteristic, such as the amplitude of the audio signal (its volume or “velocity” in the musical sense), may be increased or decreased by increasing or decreasing the (overall) magnitude of velocity across one or multiple angular dimensions, mirroring one facet of bowing technique. That is, the second audible characteristic may be varied as a function of speed of the controller in one or multiple angular dimensions. The first audible characteristic of the audio signal, such as musical pitch (frequency) or timbre, may be controlled via rotation in the first angular dimension (e.g. as a function of vertical “pitch” angle of the controller measured relative to gravity, or “roll” angle measured about an intrinsic axis of the controller device).

In a first of the described embodiments, the amplitude of the audio signal is sustained yawing and/or pitching motion, being a function of overall speed of the controller in the pitch and yaw dimensions, whilst musical pitch (frequency) is controlled based on absolute pitch angle relative to gravity. Timbre is controlled based on absolute roll angle. In this example, both amplitude and frequency are dependent on the yaw dimension, being controlled as functions of pitching/yawing speed (overall speed across the pitch and yaw dimensions) and pitch angle respectively; yaw angle is not used directly for control, meaning the controller does not require calibration in the yaw dimension. The player holding the controller device can face in any direction, but the “scale” over which they play is fixed in terms of vertical orientation (pitch angle). For example, notes of a quantized scale may be mapped to pitch angle “buckets” that are fixed in space. This allows the player to develop musically-appropriate skills though precise repetition up and down the quantized scale, or apply their existing skills with musical precision.

The audible characteristic may be varied within a configurable musical pitch range over a fixed range of orientations in the first angular dimension (e.g. in the range [−90°, +90°]), whereby increasing the musical pitch range causes the musical pitch of the audio signal to be varied with increased sensitivity to changes in the absolute orientation.

Such embodiments allow the bowing modality to be adapted to different skill levels. For example, in the case that notes of a scale are mapped to pitch angle buckets (sub-ranges), increasing the number of notes in the scale has the effect of narrowing each pitch angle bucket, requiring a greater skill level for precise playing. As a learning aid, the musical pitch range may be gradually increased, in line with the skill level of player.

The method of claim 1, wherein the audio synthesizer control signals cause the second audible characteristic to be varied in dependence on speed in the second angular dimension.

In embodiments, the audio synthesizer control signals may cause the second audible characteristic to be varied as a function of speed measured across the first and second angular dimensions.

The second audible characteristic may comprise an amplitude of the audio signal, the amplitude increasing with increases in the speed.

The first angular dimension may be a pitch dimension and the second angular dimension may be a yaw dimension.

The audio synthesizer control signals may cause the first audible characteristic to be varied as a function of absolute orientation of the control device as measured in the first angular dimension.

The absolute orientation may be a pitch angle above or below a horizontal plane lying perpendicular to the direction of gravity.

The first audible characteristic may be varied as a quantized function of the pitch angle.

The first audible characteristic may comprise a frequency of the audio signal.

The frequency of the audio signal may be varied within a configurable frequency range over a fixed range of orientations in the first angular dimension, whereby increasing the frequency range may cause the frequency of the audio signal to be varied with increased sensitivity to changes in the absolute orientation.

The inputs may denote sensed changes in orientation of the control device in a third angular dimension, and the audio synthesizer control signals may cause a third audible characteristic of the audio signal to be varied responsive to changes in orientation of the control device in the third angular dimension.

The additional characteristic may be a timbre of the audio signal.

The third angular dimension may be a rotational dimension, such that the third audible characteristic is varied by rotating the control device about a longitudinal axis of the control device.

The third audible characteristic may be varied as a function of roll angle.

The audio synthesizer may generate the audio signal via granular synthesis applied to an audio sample based on a time position within the audio sample, and changes in the orientation of the control device in the first angular dimension may cause the time position within the audio sample to be changed.

The time position within the audio sample may be varied as a function of the absolute orientation of the control device as measured in the first angular dimension.

The method may comprise receiving an audio sample from an audio capture device of the control device, and providing the audio sample to the audio synthesizer for generating the audio signal via said granular synthesis.

The inputs may comprise accelerometer, magnetometer and gyroscope readings (measurements), and the method may comprise applying a Kalman or non-Kalman filter to the inputs, in order to measure the orientation changes in the first and second angular dimensions.

A second of the described embodiments operates on similar principles, but using granular synthesis, with pitch angle controlling a time position within an audio sample used for granular synthesis (rather than frequency).

A second aspect herein provides a method of generating audio synthesizer control signals, the method comprising: receiving at a processing component, from an orientation sensor of a controller device, inputs denoting sensed angular velocity of the control device in at least one angular dimension; processing the inputs to detect a strike action, as a peak in said angular velocity above a strike threshold; in response to detecting the hit action, outputting a percussion control signal to an audio synthesiser to cause the audio synthesiser to output an audio signal.

This second aspect provides a “percussion” modality, which mirrors traditional drumming techniques, but which (in contrast to traditional drum controllers, such as drum pads) does not require the player to strike a physical surface. Hence, the device is not required to withstand repeated and forceful physical impact, and can therefore be constructed using simpler and cheaper components and manufacturing techniques. The strike action requires the player to manipulate the device in a similar manner to a drumstick, mirroring the physical sensation of a drumstick rebounding from a drumskin, but without any physical rebound surface. The device can therefore be used to learn appropriate drumming technique that can subsequently be transferred to more advanced percussion instruments.

A drum “hit” is triggered by a velocity peak above the strike threshold, which is designed to mimic the point at which a physical drumstick would strike a drum skin or other percussion surface (before slowing down as the percussion surface provides resistance). A full drum hit would generally be followed by a rebound from the surface, which could, in principle, be detected as a zero-velocity point. However, the second aspect recognizes that it is not, in fact, necessary to verify that a rebound occurs (which allows the hit action to be detected with lower latency—as little as a single measurement interval in some embodiments, without having to wait to verity if a subsequent zero-point occurs), whilst also allowing two consecutive hits of the same “drum”. Technically, the controller does not need to rebound to trigger a hit, but it must be a significant rotational movement which “peaks”. The user could theoretically slow and carry on again, but this would be physically tricky. Hence, in practice, it is possible to detect natural drumming action based on peak detection with low latency.

Embodiments of the second aspect provide extremely low-latency rebound detection, based on raw (unfiltered) angular velocity measurements received directly from a gyroscope of the controller. This low-latency mode of operation is particularly beneficial as even a small latency can be highly detrimental in this context.

The orientation sensor may comprise a gyroscope and the hit action may be detected from raw angular velocity measurements provided by the gyroscope.

The hit action may be detected from a current measurement angular velocity and two preceding measurements only.

A sign of the peak may be used to determine a sound selection parameter, whereby strike actions in different directions trigger different sounds.

The gyroscope may measure pitch and yaw angular velocity. A positive peak in yaw angular velocity above a first strike threshold may trigger a first sound, a negative peak in yaw angular velocity below a second strike threshold may trigger a second sound, a positive peak in pitch angular velocity above the first or a third strike threshold may trigger a third sound, and a negative peak in pitch angular velocity above the second or a fourth strike threshold may trigger a fourth sound.

A third aspect herein provides an audio synthesizer control device for generating audio synthesizer control signals, the audio synthesizer control device comprising: an elongated body comprising a handle portion lying along a longitudinal axis of the elongated body and an arm portion extending outwardly from the handle portion along the longitudinal axis, the elongated body supporting: a multi-dimensional orientation sensor, located in or on in the arm portion, and configured to sense changes in orientation of the audio synthesizer control device in multiple angular dimensions; and a computer coupled to the multi-dimensional orientation sensor and configured to process inputs from the multi-dimensional orientation sensor, and generate audio synthesizer control signals for controlling multiple audio signal characteristics based on sensed changes in orientation in the multiple angular dimensions.

The audio synthesizer control device may comprise an audio synthesizer arranged to receive the audio synthesizer control signals.

The computer may be configured to implement the audio synthesizer.

Alternatively or additionally, the audio synthesizer control device may comprise a control interface configured to output the audio synthesizer control signal output to and external audio synthesizer.

The multi-dimensional orientation sensor may comprise a multi-axis accelerometer, a multi-axis gyroscope and a multi-axis magnetometer.

The computer may be configured to apply a Kalman or non-Kalman filter to the inputs from the multi-dimensional orientation sensor, in order to compute a filtered estimate of at least two of: a yaw angle, pitch angle and roll angle of the audio synthesizer control device, the inputs comprising at least two of: acceleration, angular velocity and magnetic field measurements.

The elongated body may have a center of mass located in an index finger region of the handle portion such that, in use, the weight of the audio synthesizer controller is supported by an index finger of a hand gripping the handle portion.

The audio synthesizer control device may comprise an audio input device, the computer configured to provide a captured audio sample from the audio input to an audio synthesizer controlled by the synthesizer control signals.

In any of the above, the controller device may comprise a trigger switch, which may be selectively activated and deactivated to instigate and terminate the audio signal. Alternatively or additionally, the trigger switch may be selectively activated or deactivated to prevent changes in orientation of the controller device in one or more of the angular dimensions from varying one or more of the characteristics.

Further aspects herein provide computer program code configured, when executed on one or more computers, to implement any of the above steps or functions, and a computer system comprising one or more computers configured to implement the same.

### BRIEF DESCRIPTION OF FIGURES

Particular embodiments will now be described, by way of example only, with reference to the following schematic figures, in which:

FIG. 1A shows a perspective view of a hand-held audio synthesizer controller device;

FIG. 1B shows a side view of the device of FIG. 1A;

FIG. 1C shows an orientation of the device of FIG. 1A expressed in a 3-degrees of freedom angular coordinate, in terms of pitch, roll and yaw angular dimensions;

FIG. 1D shows how pitch, roll and yaw angles may be defined in terms of Euler angles;

FIG. 1E illustrates the principles of pitch and roll angle measurement based on linear acceleration;

FIG. 2 shows a function block diagram of an audio generation system;

FIG. 3A shows functional components of an audio generation system that cooperate to provide note-based audio synthesis controlled via a gesture-based bowing modality;

FIG. 3B shows a transformation of a (pitch, yaw) angle pair to spatial coordinates of a point on a sphere;

FIG. 3C shows an example of controller motion causing variations in note velocity and musical pitch;

FIG. 3D shows functional components of an audio generation system that cooperate to provide granular audio synthesis controlled via a gesture-based bowing modality;

FIG. 4A shows functional components of an audio generation system that cooperate to provide gesture-controlled percussion synthesis via a gesture-based percussion modality; and

FIGS. 4B and 4C illustrate certain principles of operation underpinning a gesture-based percussion modality.

### DETAILED DESCRIPTION

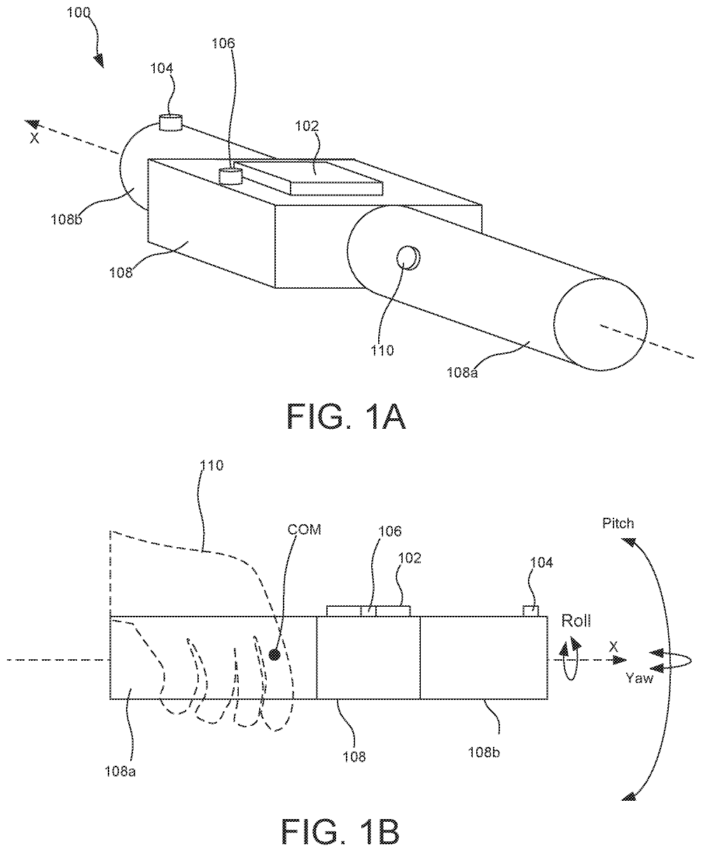

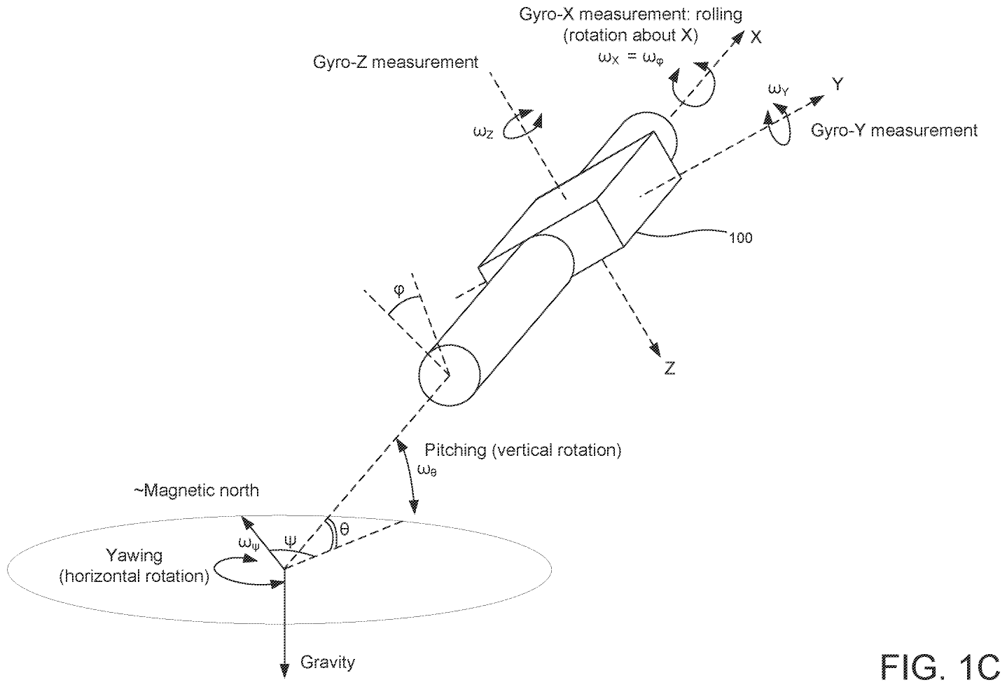

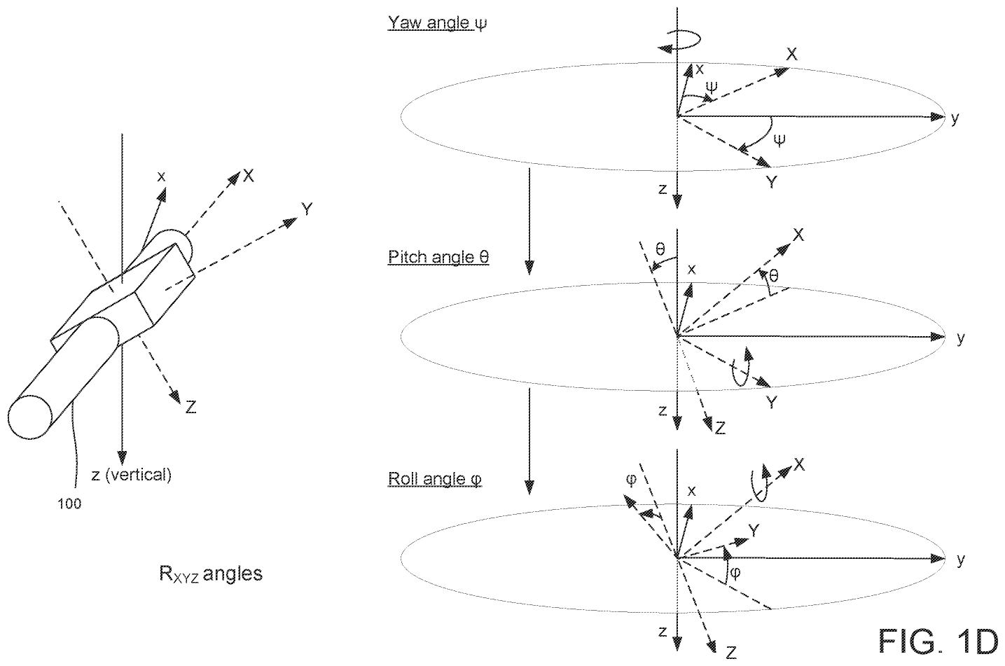

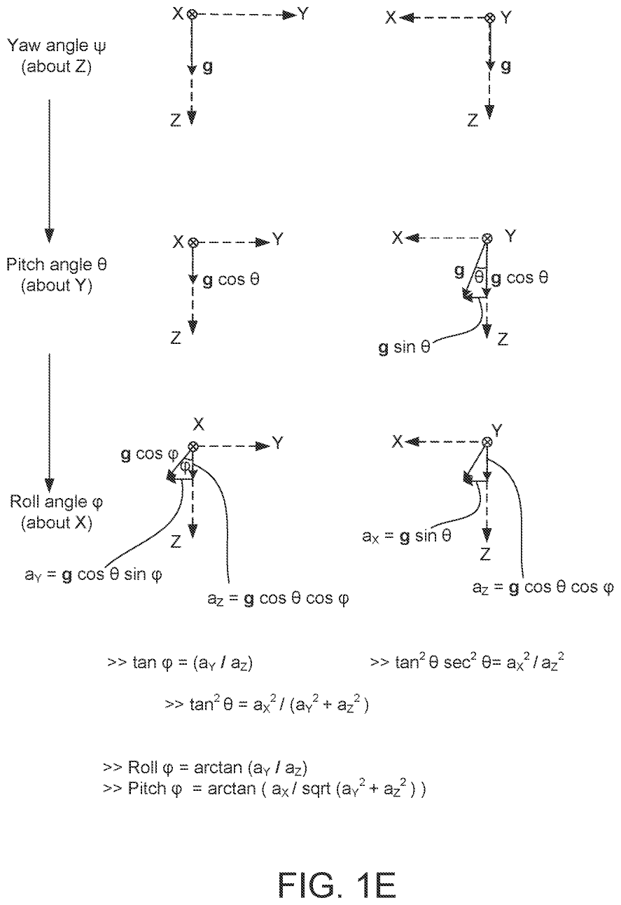

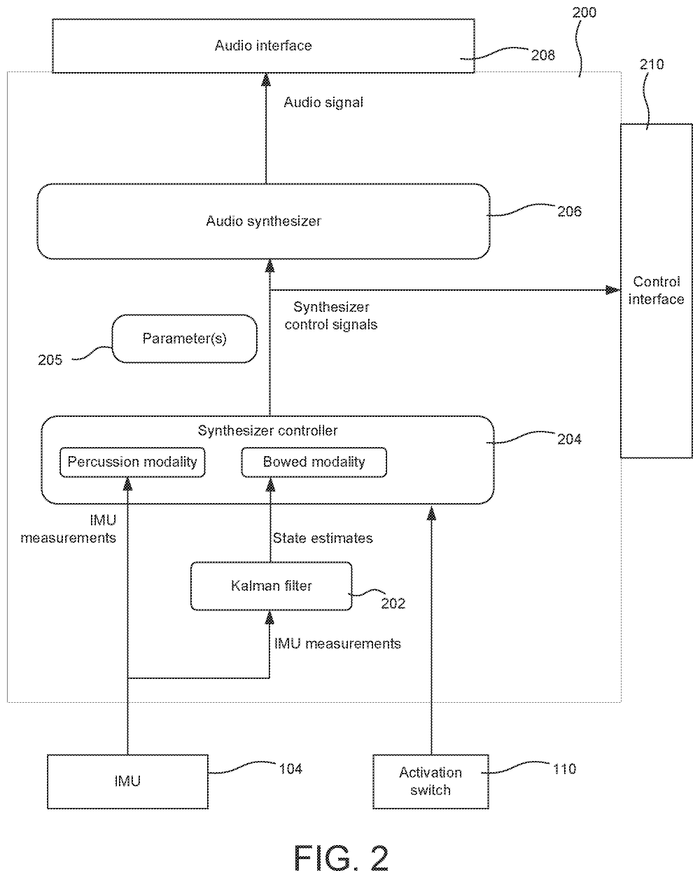

FIGS. 1A and 1B show, respectively, perspective and side views of a hand-held audio synthesizer controller device 100 (controller). The controller 100 is a handheld device comprising a body 108 and various component supported by the body. Such components may, for example, be attached to the body, or housed or integrated within it. The components include a miniature computer 102 and, coupled to the computer 102 at least one multi-dimensional orientation sensor 104, and at least one audio capture device 106 in the form of a microphone.

The controller 100 has multiple operating modes which may be selected to effect different gesture-based control modalities, as described in further detail below. A selection mechanism (not shown) may be provided on the device for this purpose, such as button or another form of switch. Other forms of input mechanisms (such as a touchscreen) are viable, although the device 100 is primarily gesture-controlled and does not require any sophisticated input mechanism. In contrast to game controllers and the like, the device 100 is capable of operating in a “screenless” manner, as a gesture-controlled musical instrument that does not rely on visual feedback from any screen or display system.

The orientation sensor 104 is a 9-DOF IMU that measures acceleration, angular velocity and magnetic field in three dimensions of space. Note that the term “sensor” can, in general, also refer to a system of multiple sensor devices at one or more locations on/in the controller 100. In the following examples, the controller 100 is equipped with a three-axis accelerometer, three-axis gyroscope and three-axis magnetometer that allow attitude (pitch angle and roll angle) of the controller 100 to be measured using gravity as a reference, and yaw angle using magnetic north as a reference.

The body 108 of the controller 100 is shown to comprise a handle portion 108a for receiving a human hand and an arm portion 108 on/in which the orientation sensor 104 is located. The handle portion 108a and the arm portion 108b extend along an intrinsic longitudinal axis of the device, denoted by X.

The player manipulates the controller by “pitching” the controller 100 vertically, “rolling” the controller 100 about its longitudinal axis X in a twisting motion, and rotating the controller 100 horizontally (“yawing”). These three types of rotation can be used to control different facets of audio synthesis, as described in further detail below.

FIG. 1B shows an outline of a human hand 110 gripping the handle portion 108a. The handle portion 108 is shaped and dimensioned to permit a human hand to extend sufficiently far around the circumference the handle portion 108 in a firm grip, such that a user (player) can comfortably manipulate the controller 100 in the manner described above. The device 100 has a center-of-mass (COM), located in an index finger region of the handle portion 108, such that the COM is located in the vicinity for the user's index finger in use. This ensures comfortable manipulation of the controller 100 even over extended periods of use. A trigger switch 110, in the form of a push button switch, is shown located in the handle gripped 108a, located so that it can be used by the hand gripping the handle portion 108a. The orientation sensor 104 is located in/on the arm portion 108b at a distance along the X-axis from the handle portion 108a suitable for detecting the range of motions described herein (e.g. 15-30 centimetres or so from the far end of the handle portion 108a has been found to be sufficient).

FIG. 1C shows a 3DOF (degrees-of-freedom) angular coordinate system in which the orientation of the controller 100 in 3D space is expressed in terms of pitch, roll and yaw dimensions. A vertical z-axis is defined relative to the direction of gravity (−z).

Yaw rotation is defined as rotation about the z-axis. A yaw angle ψ is shown, which is a horizontal orientation of the controller 100 relative to some relatively stable reference direction (such as approximate magnetic north—although, as described in further detail below, a specific reference direction in the horizontal plane is not required, as the yaw angle ψ is not used directly for control). The yaw angular velocity ω_{ψ} is defined as the angular velocity of the controller 100 about the z-axis.

Pitch rotation is defined as rotation of the controller 100 relative to the horizontal (xy) plane lying perpendicular to the z-axis. A pitch angle θ of the controller 100 is measured as an elevation angle of the controller above or below the xy plane. Pitch angular velocity ω_{θ} is defined as the rate of change of pitch angle θ.

Roll rotation is defined as rotation of the controller 100 about its intrinsic longitudinal axis X, and a yaw angle φ quantifies an extent of roll rotation about the longitudinal axis X. Angular velocity in the roll dimension (about the X axis) is denoted by ω_{φ}.

Unless otherwise indicated, the capital letters X, Y, Z are used to denote intrinsic axes of the controller 100, and the lowercase letters x, y, z are to denote extrinsic axes in the world. It is convenient but not essential to define the z axis as aligned with the direction of gravity and the x-axis as approximately aligned with magnetic north. As explained below, the present techniques do not, in fact, require any calibration of the x-axis, and only require that it remains reasonably stable.

The orientation sensor 104 returns measurements in the intrinsic coordinate system of the device. For convenience, it is assumed that each component sensor provides a measurement along the same set of intrinsic axes X, Y, Z. The roll angular velocity ωφ=ω_{X} (angular velocity as measured by the gyroscope about the longitudinal X-axis). Angular velocity measured by the gyroscope about the intrinsic Y and Z axes are denoted ω_{Y} and ω_{Z}. Acceleration and magnetic moment, as measured by the accelerometer and magnetometer along the intrinsic X-axis, are denoted a_{X} and m_{X}, with equivalent used for measurements for measurement along the Y and Z axes. Pseudocode notation is also used to denote these nine measurements as:

(ax, ay, ax, gx, gy, gz, mx, my, mz).
# accelerometer (ax, ay, ax)
# gyroscope (gx, gy, gz)
# magnetometer (mx, my, mz)

Although the code uses lower case notation, the measurements are with respect to the intrinsic X, Y, Z axes.

FIG. 1D shows how the pitch, roll and yaw angles may be formulated in terms of Euler angles. Conceptually, a (yaw, pitch, roll) tuple can be seen as describing a given orientation in terms of a sequence of rotations that would be required to obtain that orientation from an initial orientation in which the intrinsic X, Y, Z axes are aligned with the extrinsic x, y, x axes. In this description, a convention is adopted that the tuple of (ψ, θ, φ) angles implies the orientation that would be obtained by first rotating the controller 100 about its Z-axis by ψ (yawing), then rotating it by θ about its Y-axis (pitching), and finally rotating it by φ about its X-axis (rolling). The definition of pitch roll and yaw angles illustrated in FIG. 1D is sometimes referred to as the R_{XYZ} convention (roll-pitch-yaw). Note that, with the angles defined in this way, the pitch and yaw angles are absolute (being defined relative to fixed, or at least relatively stable reference directions in the world, such as those of gravity and magnetic north), whereas yaw is relative (about the longitudinal axis X of the device itself). As will be appreciated, this is merely one possible convention, and 3D orientation can be represented in other ways (including quaternion representation, as in the implementation described below).

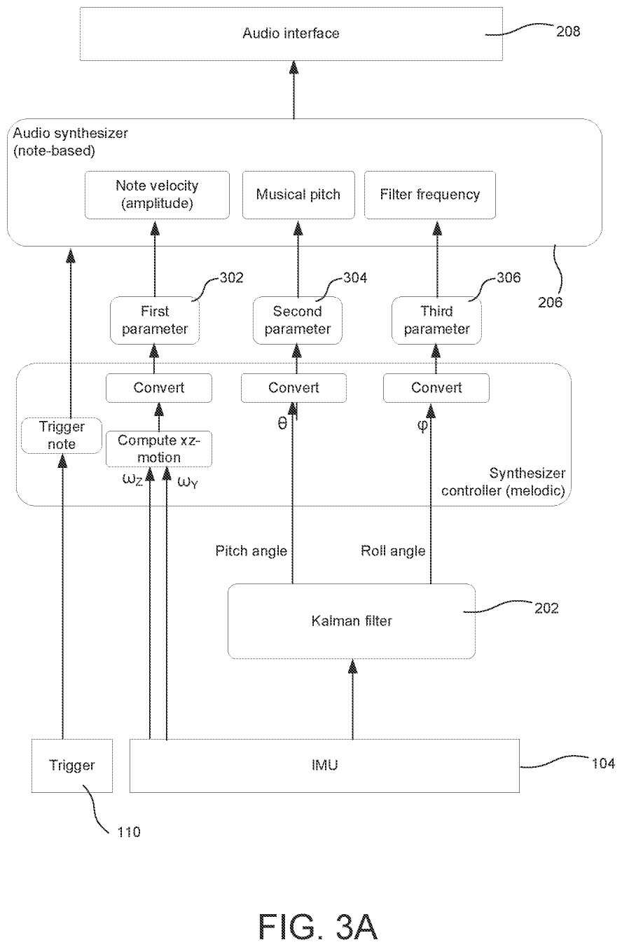

FIG. 2 shows a function block diagram of an audio synthesis system 200, implemented in the on-board computer 102. The computer 102 comprises at least one processor, such as a central processing unit (CPU), digital signal processor (DSP) etc. A programmable processor is couples to a memory, which in turn holds program instruction that, when executed on the processor, cause the processor to carry out the functions disclosed herein. Whilst a software implementation with a general purpose processor is generally envisaged, the processor can take other forms, with some or all of the functions could potentially be implemented in dedicated hardware instead. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include graphic processor units (GPUs) and field programmable gate arrays (FPGAs) having a circuit configuration programmable though circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like). Moreover, whilst the functions are described as being implemented on the controller 100, some or all of those functions could be implemented in an external computer(s) instead or in addition.

The audio synthesis system 200 is shown to comprise a filtering component, such as a Kalman filter 202, which received measurements from the orientation sensor 102 (IMU in this example), and processes those measurement to provide refined (filtered) measurements (state estimates). A known property of Kalman or other similar filters is that they can provide higher accuracy measurements from a combination of noisy measurements, taking into account past observations. For example, a Kalman filter applied to measurements from a multi-axis accelerometer and multi-axis gyroscope can provide refined measurements of attitude (pitch angle θ and roll angle φ) and angular velocity (ω_{θ}, ω_{ψ}) in the pitch and yaw dimensions (although, in the examples below, the measured angular velocities (ω_{Y}, ω_{Z}) about the intrinsic Y and Z axes are used instead). The addition of measurements from a multi-axis magnetometer can improve those estimates (and also allow yaw angle ψ to be measured, although as noted that is not required in this example implementation). Although a Kalman filter is described, other forms of filter can be used to fuse sensor measurements from the orientation sensor 102.

Whilst a magnetometer is generally preferred, it is not necessarily required, nor is the Kalman filter required to compute the yaw angle ψ. Without a magnetometer, it is not possible to obtain an absolute estimate of yaw angle ψ in the world. However, the yaw angle ψ is not required in the described examples. It is possible to implement Kalman filtering using only 6-DOF acceleration and gyroscope measurements, to obtain filtered estimates of the pitch and yaw angle θ, φ. Together with the measured angular velocities (ω_{Y}, ω_{Z}), that is sufficient to implement the described control modalities. Nevertheless, as noted, there may be benefits in the addition of the magnetometer provide another input to the Kalman filtering algorithm, to improve stability and counteract drift errors, by providing an additional stable reference in the world.

Two control modalities are described below-“bowed” and “percussive”. The bowed modality used filtered measurements of (θ, φ) as a basis for audio synthesizer control. That is, pitch angle θ and roll angle φ, as measured in the extrinsic world coordinate system. Whilst pitch and roll angle θ, φ directly control respective characteristics of an audio signal, the yaw angle ψ is not used directly: the third variable that controls the audio signal is overall speed across the pitch and yaw dimensions, estimated directly from the gyroscope measurements (ω_{Y}, ω_{Z}) (see below).

The percussive modality uses only raw, unfiltered measurements of (ω_{Y}, ω_{Z}) as a basis for audio synthesizer control, where ω_{Y} and ω_{Z} denote angular velocity as measured directly by the orientation sensor 100 about the intrinsic Y and Z axes of the controller 100.

It will be appreciated that these two modalities are described by way of example. Whilst each modality has particular advantages, the present disclosure is not limited to these modalities, and the techniques can be extended to implement different forms of gesture-based via orientation and/or angular motion tracking.

A synthesizer controller 204 receives the filtered measurements from the Kalman filter 202 and/or the IMU 104 directly, and uses those measurements to generate synthesiser control signals in real-time. Among other things, the synthesizer control signals can trigger the generation audio signals, and set/vary one or more characteristics of the audio signals via parameter(s) embedded in control signals, in a format that is interpretable by an audio synthesizer receiving the control signals. MIDI is one example of a messaging protocol that may be used to generate such control signals. Another example is Open Sound Control. The synthesizer controller 204 also receives certain “raw” (unfiltered) measurements from the IMU 104, and is coupled to the trigger switch 110.

FIG. 2 shows an internal audio synthesizer 206 implemented onboard the controller 100 itself that receives the control signals from the synthesizer controller 204. An audio interface 208 of the controller 100 is shown receives audio signals from the audio synthesizer 206. Such signals may be received in digital or analogue form, and the audio interface 208 is generally refers to component or device that can output audio signals in audible form from the controller 100 itself or convey such audio signals to an external audio output device for outputting in audible form (e.g. via a wired audio jack connection, or wireless medium). Hence, the audio interface 208 could, for example, take the form of a sound card and integrated loudspeaker of the controller itself 100, an analogue interface (such as an audio jack interface), or a digital wired or wireless interface capable of carrying digital audio signals.

A control interface 210 is shown, which can receive audio synthesizer control signals form the synthesizer controller and convey those signal to an external audio synthesizer. Whilst the description below refers to the internal audio synthesizer 206 of the controller 100, all such description applies equally to an external audio synthesizer that receives control signals via the control interface 210. More generally, any of the components of FIG. 2 may be implemented externally to the controller device 100. For example, the controller device may simply capture and output IMU measurements, with the Kalman filter 202 and synthesizer controller 204 implemented externally. As another example, the Kalman filter 202 may be implemented on the control device, and the controller may provide IMU measurements and filtered state estimates to an external synthesizer controller.

Although shown as separate components, the audio interface 208 and control interface 108 may be provided by the same physical interface at the hardware level (e.g. a USB or Bluetooth interface). In alternative embodiments, the controller 100 may be implemented without any internal synthesizer 206, such that is only acts as a controller to an external synthesiser, or without the control interface 210, in which case the controller 100 only controls its own internal synthesizer 206.

An audio synthesiser can be implemented in numerous different ways, in analogue or digital hardware, software, or any combination therefore. In the present example, the audio synthesizer 206 is programmed in SuperCollider, which is an environment and programming language for real-time audio synthesis. The synthesizer control signals may be carried as UDP data over an internal network of the computer 102 and/or to the control interface 210 for controlling an external synthesizer.

The synthesizer controller 204 supports the bowed and percussion modalities. As described below, although both modalities are gesture-based, the processing of the IMU measurements is quite different. The bowed modality is based on filtered pitch, roll and yaw angle measurements provided by the Kalman filter 202, to allow precise control of different audio signal characteristics. The percussion modality is based on raw IMU measurements to provide low latency percussion control. The different modalities are provided via different operating modes of the synthesizer controller 204.

Although the orientation of the device is represented in terms of pitch, roll and yaw angles, these are known to suffer from “gimble” lock issues. The Kalman filter 202 may instead perform a sensor fusion on the nine sensors to give a quaternion, which is an alternative representation of the device's rotation in real space that does not suffer from gimble lock.

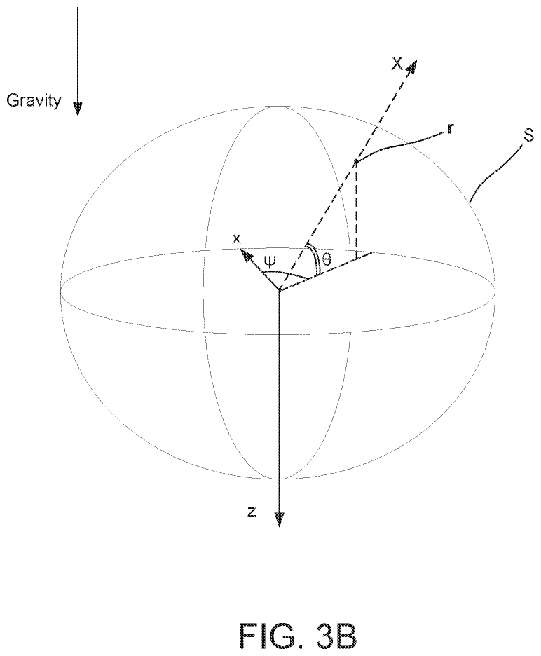

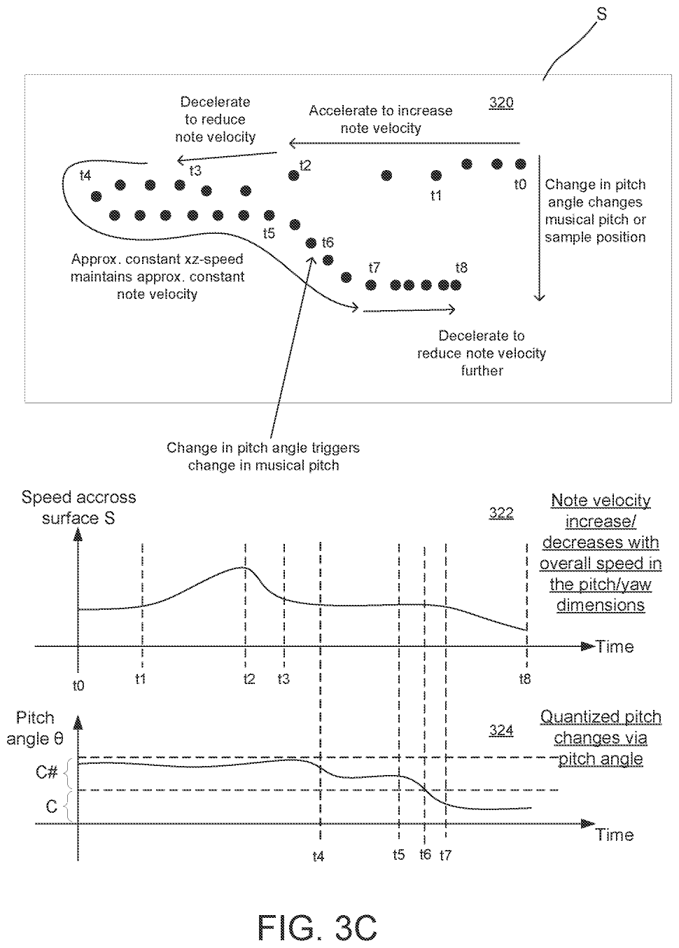

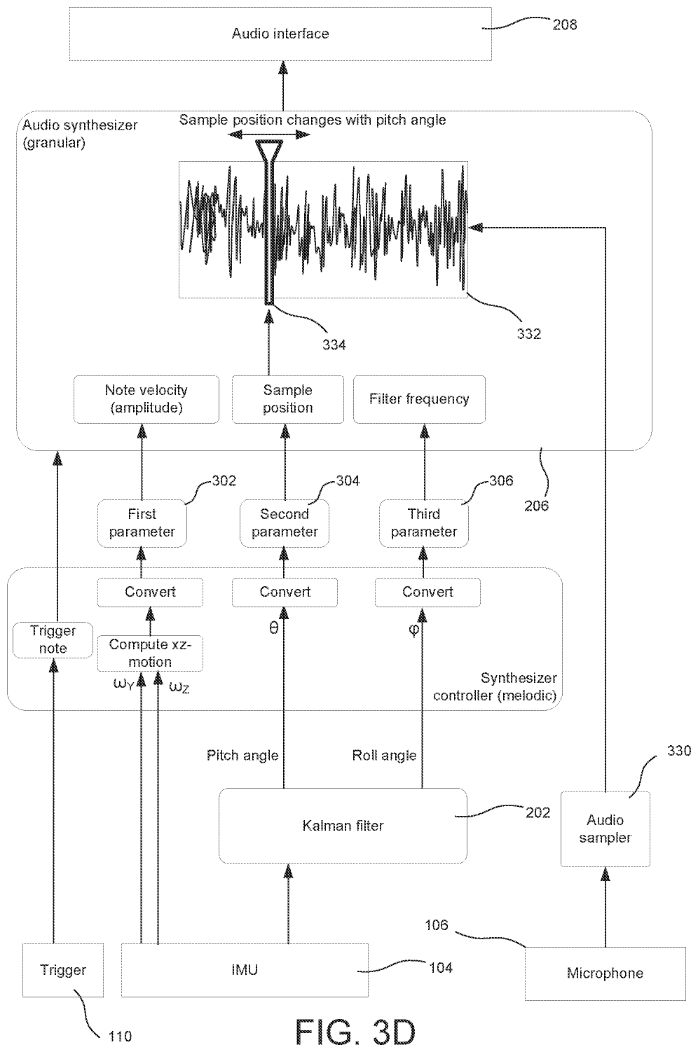

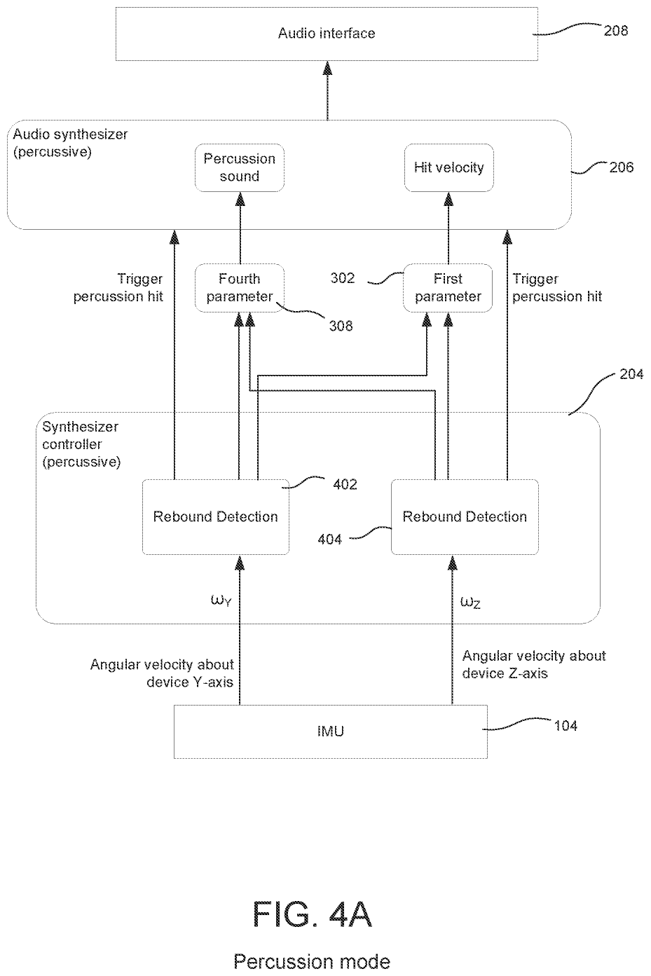

FIG. 3A shows the synthesizer controller 204 in a first operating mode to provide the bowed modality. The synthesizer controller 204 is shown to receive filtered yaw, pitch and roll angle measurements (ψ, θ, φ) from the Kalman filter 202.

The trigger switch 110 is used to trigger the generation of an audio signal. When the trigger switch 110 is activated, the synthesizer controller 204 causes the audio synthesizer 206 to generate an audio signal at the audio interface 208. In this example, three characteristics of the audio signal are controlled via first, second and third parameters 302, 304, 306, which in turn are set and varied via gesture-control.

The 9-DOF IMU provides a continuous stream of measurements over a series of timesteps. Each measurement is a tuple of nine measurements:
(a_{X}, a_{Y}, a_{Z}, ω_{X}, ω_{Y}, ω_{Z}, m_{Z}, m_{Y}, m_{Z}),
where a_{X}, ω_{X}, m_{X} denote, respectively, linear acceleration of the controller 100 along its X-axis as measured by the accelerometer (also denoted ax, gx and mx respectively), angular velocity of the controller 100 about the X-axis as measured by the gyroscope, and magnetic field strength along the X axis as measured by the magnetometer, in a given time step. The Y and Z subscripts denote equivalent measurements relative to the Y and Z axes of the controller 100 (also denoted ay, gy and my, and az, gz and mz respectively).

The Kalman filter 202 receives the stream of measurements, and uses those measurements to update an estimate of the yaw, pitch and roll angle measurements (ψ, θ, φ) (the “state” of the controller 100 in this implementation). For each time step t, the Kalman filter 202 takes the current estimate of the state, applies the accelerometer readings in that time and makes a prediction about the next state at time t+1. The prediction is then compared to the readings from all the IMU sensors in time step t+1, with some dampening. This is used to modify the prediction which both smooths out sensor noise as well as compensates for drift. By way of example, a suitable Kalman filtering algorithm that may be applied in this context may be found at https://github.com/niru-5/imusensor/blob/master/imusensor/filters/kalman.py, the contents of which is incorporated herein by reference.

FIG. 1E illustrates certain principles of the measurement of pitch and roll angles based on measured acceleration in three dimensions. With pitch, roll and yaw defined as in FIG. 1C (the R_{XYZ} convention), it can be seen that the pitch and yaw angles relate to acceleration as measured in the frame of reference of the controller 100 as:

$$roll = a tan 2 ( ay , az )$$

$$pitch = a tan 2 ( ax , sqrt ( ay \hat{} 2 + az \hat{} 2 ) )$$

The yaw angle can then be derived from the above based on a 3D measurement of magnetic moment, as set out in the above reference. Note, the above assumes the device 100 is not accelerating, and that only gravitational field is measured by the accelerometer. This is not the case in general. However, this and other sources of error are mitigated by filtering the pitch, roll and yaw estimates based on the angular velocity measurements provided by the gyroscope.

A motion computation component 300 receives the measured Y and Z angular velocities ω_{Y}, ω_{Z} directly from the IMU 104, and at each time step, and uses those measurements to track pitching and yawing motion of the device. The motion computation component does so by using those measurements (ω_{Y}, ω_{Z}) to compute a current overall angular speed across the pitch and yaw dimensions (see below for further details). Alternatively, the yaw and pitch estimates (ψ, θ) from the Kalman filter could be used to compute (ω_{ψ}, ω_{θ}) (the latter being equal to the first order time derivative of the former), or the Kalman filter 202 could be configured to estimate (ω_{ψ}, ω_{θ}) using the range of inputs available to it. In practice, it has been found that it is sufficient to use the raw gyroscope measurements ω_{Y}, ω_{Z} as a basis for motion tracking in this context. A first control component 301 of the synthesizer controller 204 varies the first parameter 302 based on pitching/yawing motion as described below. The first parameter, in turn, determines note velocity in the musical sense (generally corresponding to the amplitude or volume of the audio signal or, in musical terms, how “hard” a note is played).

A second control component 303 varies the second parameter 304 as a function of pitch angle θ above or below the extrinsic xy-plane. In the example of FIG. 3A, the audio synthesizer 206 is operating in a note-based mode, in which it outputs an audio signal with a musical pitch (audible frequency) that is determined by the second parameter 304. For example, the audio signal could be a simple sine-wave, square wave, or sawtooth signal, with the second parameter 304 controlling the fundamental frequency and the frequency of any harmonics. More complex signals may be generated, based e.g. on existing samples or using combinations of oscillators and/or with multiple fundamental frequencies controlled by the second parameter 304.

Musical pitch may be varied as a quantized function of pitch angle θ, with a variable musical pitch range. For example, musical pitch may be varied over a fixed range of pitch angles, e.g. [−90, 90] degrees, that is divided into sub-rages (“buckets”), with each bucket mapped to a note of a musical scale.

Thus, the player varies the pitch by rotating the controller 100 up or down, to coincide with a given pitch bucket. The sensitivity depends on the size of each bucket. By increasing the number of notes in the scale (or otherwise increasing the musical pitch range), the size of each bucket is decreased, requiring more precise manipulation of the pitch angle θ of the controller 100. Hence, the musical pitch range can be adapted to different skill levels, or gradually increased as a player becomes more experienced.

The player has the option of deactivating and reactivating the trigger switch 110 as they play, e.g. temporarily deactivating it in order to change note. When the trigger switch 110 is deactivated, the audio signal does not necessarily terminate abruptly. Rather, the amplitude may gradually reduce over a desired time scale (the release). However, whilst the trigger switch is deactivated 110, changes in pitch angle θ do not alter the second parameter 304, allowing the user to change the pitch angle to select a new note without triggering any intermediate notes, before re-activating the trigger switch 110.

A third control component 305 varies the third parameter 306 as a function of roll angle q about the intrinsic longitudinal Y-axis of the controller 100. In this example, the third parameter 305 controls musical “timbre” of the audio signal. For example, the audio signal may be filtered before it is outputted to the audio interface (e.g. using a high-pass filter, low-pass filter, band-pass filter, notch-filter etc. or any combination thereof), and the third parameter 306 may control a filter frequency (or frequencies) of the filter(s). The player can thus alter the timbre of the audio signal by rolling the device about its X-axis (varying the third parameter 306 may or may not require the tigger switch 110 to be activated, depending on the implementation).

The processing applied by the motion compensation component 300 is described in further detail with reference to FIGS. 3A and 3B. Each (>, θ) angle pair may be conceptually mapped to a corresponding point on a 2D surface S (manifold), as shown in FIG. 3A. In effect, pitching and yawing motion is tracked based on changes in these points over time.

FIG. 3B illustrated the geometric principals of the transformation from the (θ, ψ) angle pair to corresponding coordinates on S. A point r is shown, which is defined as the intersection between the surface S of a sphere of arbitrary radius R and the Y-axis of the controller 100, whose orientation in 3D space is defined by the pitch and yaw angles (θ, ψ).

In practice, a simpler calculation can be carried out, to estimate an overall pitching/yawing speed directly from the IMU measurements as:

$$rotvel = np . sqrt ( np . square ( gy ) + np . square ( gz ) )$$

That is to say, the overall speed is estimated as the square root of the sum of the squares of ω_{Y} and ω_{Z} (based on Pythagoras's theorem). Conceptually, “rotvel” (Ω_{XY}) is the overall speed at which the point r moves across the surface S of the sphere. This is based on the observation that Ω_{XY}²=ω_{Y}²+ω_{Z}²=ω_{ψ}²+ω_{θ}², allowing the gyroscope Y and Z measurements to be used directly. Changing the roll angle φ has no effect on the point r on the surface S, nor does linear motion of the controller 100 along any of its intrinsic axes.

FIG. 3C shows how pitching/yawing motion may be tracked based on overall pitching/yawing speed Ω_{XY}.

FIG. 3C shows an example motion profile 320 within the sphere's surface S. Between time t0 and t4, the controller is rotated counter-clockwise about the z-axis (negative yawing), maintaining an approximately constant pitch angle. From time t4 to t8, the controller 100 is rotates clockwise about the z-axis (positive yawing), with only a slight reduction in pitch angle initially (not sufficient to change pitch angle bucket) up to time t5, before gradually reducing the pitch angle as the controller 100 between time t5 and t7, and finally maintaining the new pitch angle between time t7 and t8.

The motion profile results in a speed curve 322, which is Ω_{XY} as a function of time. The speed curve 322, in turn, control the first parameter 302 (note velocity in this example). Because overall speed is tracked, it is the “distance” between (ψ, θ) measurements in adjacent times steps that is germane, not the direction of change. For example, at time t4, the direction of the yawing motion changes, but this is compensated for by a slight reduction in pitch angle, to maintain constant xz-speed, and hence an essentially constant note velocity is maintained. Similarly, between times t5 and t7, and the pitch angle is reduced, the speed stays essentially constant, to maintain an essentially constant note velocity.

Reference numeral 324 denotes pitch angle θ as a function of time, with two pitch angle buckets mapped to musical notes “C” and “C#” respectively. Up to time t5, pitch angle varies at times, but stays within the C#-bucket, maintaining a musical pitch of C#. At time t5, the pitch angle θ moves to the C bucket, triggering a change in musical pitch to C.

A magnetometer would typically require calibration in order to locate true magnetic north. However, such calibration is not required in the present context. Note that the yaw angle ψ does not control any parameter directly. Only changes in the yaw angle ψ are used, in combination with changes in the pitch angle θ, to control note velocity.

As noted, accelerometer measurements can be used to fully determine the pitch and roll angles (θ, φ) of the controller 100 via simple geometry. However, this approach is potentially vulnerable to “drift” as errors accumulate. Filtering based on gyroscope measurements (without any magnetometer) could, in principle, improve the pitch and roll estimates, as well as providing yaw rate and pitch rate. However, in practice, this might be subject to accelerometer-induced drift, and require some kind of external sensor to provide a fixed reference. For example, certain game controllers are equipped with accelerometers and gyroscopes, but not magnetometers. Such game controllers would generally be used in combination with a screen and some kind of external reference. For example, the external reference could be an array of light sensors, and the game controller might be equipped with a light emitting device detectable by the external sensor array. An external sensor of this nature can also be used to compensate for drift, but limits usage of the controller to positions and orientations in which the controller can communicate with the external reference. This is less of an issue when the purpose of the controller is to interact with a screen, however, one aim herein is to provide screenless operation.

The magnetometer is used to give a real position in space using magnetic north as a reference, without any external reference. However, because only the change in yaw angle is needed, that position does not need to be absolute and therefore the magnetometer does not need to be calibrated. The sensor fusion algorithm of the Kalman filter 202 assumes an unwavering “north” but does not require this to be aligned with magnetic north (the only assumption is that it doesn't move too quickly). The user can and will move about, which may result in soft iron interference. This, in turn, may result in drift of the x-axis. However, in practice that drift is small enough for the smoothing effect of the filter to compensates for it. Hence, a benefit in using yawing motion but not yaw angle is that magnetometer calibration is not required. Another benefit is that the user is not required to face in any particular direction, nor are they confined to any particular region of space (consistent with the aim of providing a screenless device). If, for example, musical pitch were controlled based on yaw angle rather than pitch angle, this would likely require calibration of the device to set some fixed reference direction.

The magnetometer bypasses the need for assuming a starting velocity, as the magnetometer give this information in the filter 202.

Notwithstanding the aforementioned benefits of the magnetometer, as noted, it is nevertheless possible to implement the Kalman filtering in 6-DOF, with no magnetometer, in contexts where an absolute yaw angle ψ is not required.

FIG. 3D shows the synthesizer controller operating in the same mode as FIG. 3A, but with the audio synthesizer 206 now operating in a granular synthesizer mode. An audio sampler 330 is shown coupled to the microphone 106 of the controller 110. The audio sampler 330 provides an audio sample 332, captured using the microphone 106, to the synthesizer 206.

Rather than controlling musical pitch, in this configuration, the pitch angle θ controls a position (time index) 334 within the audio sample. As such, the pitch angle range, e.g. [−90,90] degrees, now maps to the duration of the sample 322 (with 0 degrees corresponding to the temporal midpoint of the sample, and +/−90 degrees to its start and end). A granular synthesis algorithm is used to generate an audio signal from the audio sample 332 based on the current position 334. An audio signal is generated based on granular synthesis, based on a set of microsamples of slightly varying length that are extracted around the current position 334. The microsamples are then played-out in a way to minimize audible repetition. This is one form of so-called “time-stretching” algorithm, where the length of a sample may be varied without varying its pitch. Consider, say, a two second sample, sweeping the pitch angle from −90 to +90 degrees over an interval of 2 second will result in an audio signal that closely resembles the original audio signal. Decreasing the speed will stretch the audio signal over a longer duration, without altering its pitch (similar to a time-stretching function in a digital audio workstation). Varying the pitch angle in the opposite direction will play the sample backwards. By selectively activating/deactivating the trigger switch 110, and varying the pitch angle, the user can play any desired sections of the audio sample 332, at any speed (in its original pitch), and in any order.

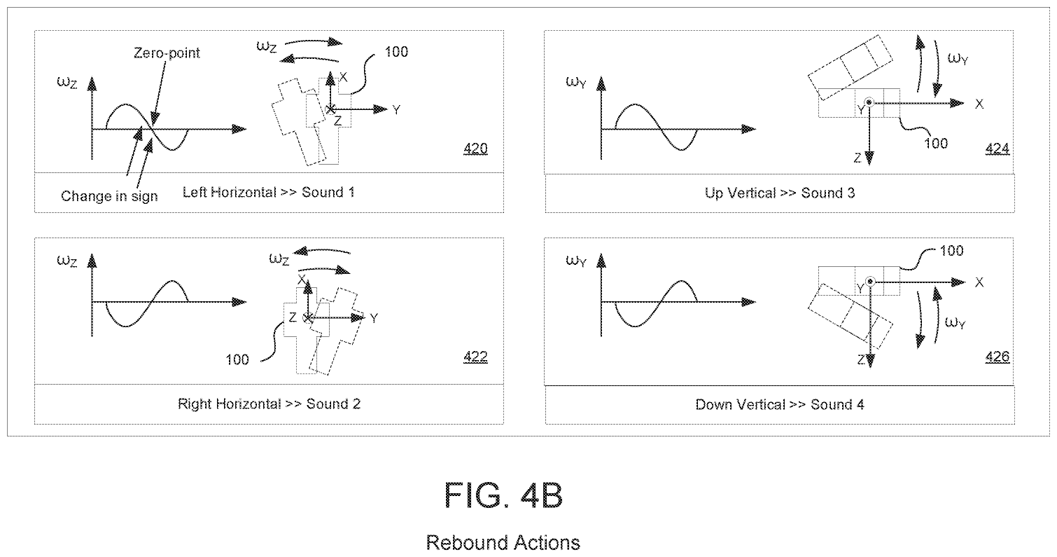

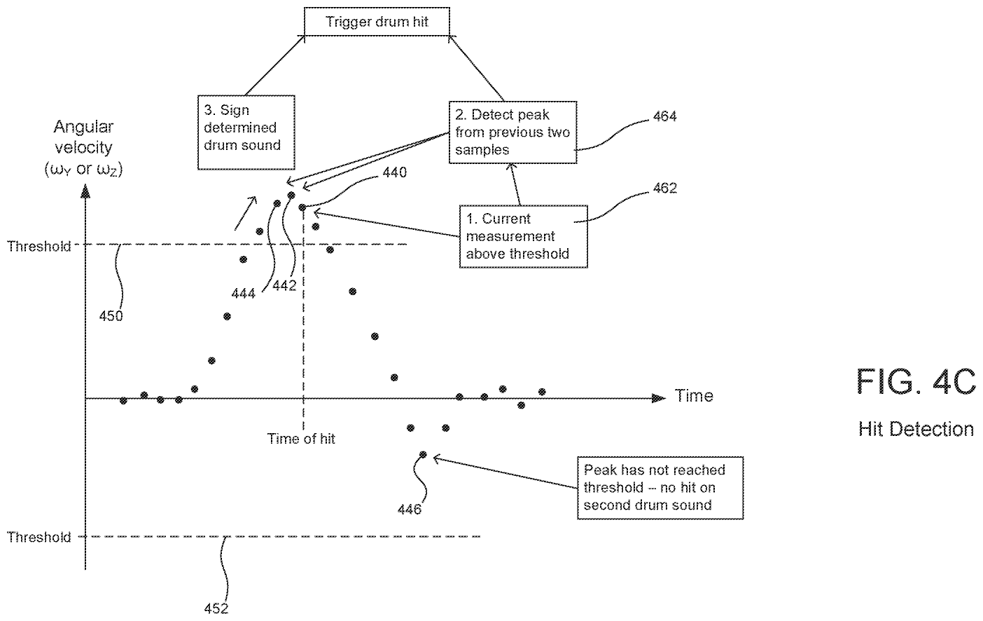

FIG. 4A shows the synthesizer controller 204 in a second operating mode, to implement the percussion modality. This is a low-latency mode of operation that uses raw gyroscope measurements only, specifically angular momentum about the intrinsic Y and Z axes of the controller 100, (ω_{Y}, ω_{Z}) (roll motion is not considered in this example). The aim is to replicate the playing style of a percussion instrument, triggering a drum “hit” (the playing of a drum sample or sound) when a rebound action is detected, but without any physical rebound surface.

First and second “rebound” detectors 402, 404 are shown, which receive raw ω_{X} and ω_{Z} measurements respectively from the IMU 105. Each hit detector 402, 404 can cause trigger a percussion sound (hit) from the audio synthesizer 206. Each rebound detector can set control a first parameter 304 and fourth parameter 308. As above, the first parameter 304 controls the velocity of the hit. The fourth parameter 308 can be varied to change the drum sound that is triggered.

A “rebound action” (or “hit”) means a change in sign of the angular velocity in question, either from positive to negative or from negative to positive. A threshold condition is also applied, requiring the angular velocity to exceed some threshold around the time of the change. This is a similar motion profile to a drumstick rebounding from the surface, but the intention is for the user to mimic that action with no physical rebound surface. Whilst, in principle, the action will be likely a rebound action (in the sense that the velocity will change direction), the algorithm does not actually check for the presence of re-bound. Rather, it is based on lower-latency peak velocity detection, with the peak corresponding to the point at which the controller 100 “hits” a virtual drum surface (before slowing and potentially rebounding, with no physical surface actually present).

FIG. 4B shows the principles of the percussion mode. It is possible to trigger one of four different percussion sounds (for example, the choice might be kick drum, snare, open high hat and closed high hat), each triggered by one of the following hit actions, with sufficient velocity: clockwise about Z, counter-clockwise about Z, clockwise about X and contraclockwise about Z. The “rebound” is said to occur at the point in time when the angular velocity in question is zero (the zero-point), and the sign (direction) of the angular velocity changes, but as noted, the algorithm does not check for the presence of rebound. The hit is instead triggered immediately after the point of peak velocity (just at the device 100 begins to slow down)

FIG. 4C shows how rebound detection may be implemented with extremely low latency, e.g. of the order of one hundredth of a second. Every raw angular velocity measurement in the angular dimension in question is processed, and compared with the previous angular velocity measurement.

Reference numeral 440 denotes a current (most recent) angular velocity measurements (gy or gz). The current measurement 440 must either be positive and exceed a first positive strike threshold 450, or be negative and below a second negative strike threshold 452 (which may or may not be of equal magnitude to the positive strike threshold 450). The algorithm determined whether one of the threshold conditions is met at step 462. In addition, the current measurement 440 will only trigger a hit if it immediately precedes a peak. The peak is detected based on the immediately preceding two measurements 442, 444 (requiring only three measurements to be buffered for each of the Y and Z dimensions, so six in total). For positive velocities, the earlier of these two measurements 442 (the middle measurement) must exceed the current measurement 442 and also the earlier measurement 444. This check is performed at step 462, for every current measurement 442 above the threshold. Steps 462 and 464 can be performed in either order or in parallel. For negative velocities, the requirement is that the middle measurement 442 is below both the current and earlier measurement 440, 444, which can be checked in parallel. Each of the Y and Z dimensions is associated with two different drum sounds (four in total). The sign of the current velocity 442 determines which of these drum sounds is triggered. The same or different thresholds may be used in the Y and Z dimensions (for example, the thresholds for the four directions may be adapted to the ease of rotating the device in a particular direction).

The algorithm of FIG. 4C can be implemented with extremely low latency-note that FIG. 4C is highly schematic and not at all to scale. In practice, tens or hundreds of measurements may be taken every second. Measurements in a short window before the current measurement are buffered. As soon as a change in sign is detected, a drum hit can be triggered if the N preceding samples satisfy the threshold condition (and that determination could be made before the second measurement 422 is received). Note that the change in sign is detected from the first measurement after the zero-point (the second measurement 422), and the threshold condition is only applied to measurements preceding this; the method does not need to wait for subsequent measurements once a change in sign has been detected.

The processing of FIG. 4C can be expressed in code as follows:

```
hit_threshold = 10
hit_scalar = 20.0
down_edge = [0,0,0]
left_edge = [0,0,0]
while(True):
  down_edge.pop(0)
  down_edge.append(gy)
  left_edge.pop(0)
  left_edge.append(gz)
  if down_edge[0] > down_edge[1] and down_edge[1] < down_edge[2] and gy <
−edge_threshold:
    e = gy / −hit_scalar; # Scale the number to make musical sense
```

| | |
|---|---|
| print(“down: { }”.format(e)) | # Print it for debug purposes |
| client.send_message(“/saber/downedge”, [e]) | # Send it to SuperCollider |

```
  if down_edge[0] < down_edge[1] and down_edge[1] > down_edge[2] and gy >
edge_threshold:
    e = gy / hit_scalar;
    print(“up: { }”.format(e))
    client.send_message(“/saber/upedge”, [e, pitch])
  if left_edge[0] > left_edge[1] and left_edge[1] < left_edge[2] and gz <
−edge_threshold:
    e = gz / −hit_scalar;
    print(“left: { }”.format(e))
    client.send_message(“/saber/leftedge”, [e, pitch])
  if left_edge[0] < left_edge[1] and left_edge[1] > left_edge[2] and gz >
edge_threshold:
    e = gz / hit_scalar;
    print(“right: { }”.format(e))
    client.send_message(“/saber/rightedge”, [e, pitch])
  time.sleep(0.01)
```

In percussion mode, hits are triggered by rotation about the intrinsic Y and Z axes. This does not require the device to be used in any particular orientation, which may be beneficial for users with physical disabilities or special needs special needs.

In some implementations, the magnitude of the angular velocity controls the first parameter 302, and hence the velocity of the triggered drum hit. For example, in the code snippet above, it can be seen that the magnitude of gx or gy is scaled by hit_scalar in order to compute a velocity parameter for the drum hit.

1. A method of generating audio synthesizer control signals, the method comprising:
receiving at a processing component, from a multi-dimensional orientation sensor of a controller device, inputs denoting sensed changes in orientation of the control device in first and second angular dimensions;
processing the inputs to generate audio synthesizer control signals; and
outputting the audio synthesizer control signals to an audio synthesizer;
wherein the audio synthesizer control signals cause a first audible characteristic of the audio signal to be varied as a function of absolute orientation of the control device as measured in the first angular dimension, and
a second audible characteristic of the audio signal to be varied responsive to changes in orientation of the control device as a function of speed of the control device measured across the first and second angular dimensions.

2. (canceled)

3. (canceled)

4. The method of claim 1, wherein the second audible characteristic comprises an amplitude of the audio signal, the amplitude increasing with increases in the speed.

5. The method of claim 1, wherein the first angular dimension is a pitch dimension and the second angular dimension is a yaw dimension.

6. The method of claim 1, wherein the audio synthesizer control signals cause the first audible characteristic to be varied as a function of absolute orientation of the control device as measured in the first angular dimension.

7. The method of claim 6, wherein the first angular dimension is a pitch dimension and the second angular dimension is a yaw dimension, and wherein the absolute orientation is a pitch angle above or below a horizontal plane lying perpendicular to the direction of gravity.

8. The method of claim 7, wherein the first audible characteristic is varied as a quantized function of the pitch angle.

9. The method of claim 1, wherein the first audible characteristic comprises a frequency of the audio signal.

10. (canceled)

11. The method of claim 1, wherein the inputs denote sensed changes in orientation of the control device in a third angular dimension, and the audio synthesizer control signals cause a third audible characteristic of the audio signal to be varied responsive to changes in orientation of the control device in the third angular dimension.

12. (canceled)

13. The method of claim 11, wherein the third angular dimension is a rotational dimension, such that the third audible characteristic is varied by rotating the control device about a longitudinal axis of the control device.

14. The method of claim 13, wherein the third audible characteristic is varied as a function of roll angle.

15. The method of claim 1, wherein the audio synthesizer generates the audio signal via granular synthesis applied to an audio sample based on a time position within the audio sample, wherein changes in the orientation of the control device in the first angular dimension cause the time position within the audio sample to be changed.

16. The method of claim 15, wherein the audio synthesizer control signals cause the first audible characteristic to be varied as a function of absolute orientation of the control device as measured in the first angular dimension and the time position within the audio sample is varied as a function of the absolute orientation of the control device as measured in the first angular dimension.

17. The method of claim 15, further comprising:
receiving an audio sample from an audio capture device of the control device;
providing the audio sample to the audio synthesizer for generating the audio signal via said granular synthesis.

18. The method of claim 1, wherein the inputs comprise accelerometer, magnetometer and gyroscope readings, and the method comprises:
applying a Kalman or non-Kalman filter to the inputs, in order to measure the orientation changes in the first and second angular dimensions.

19. A method of generating audio synthesizer control signals, the method comprising:
receiving at a processing component, from an orientation sensor of a controller device, inputs denoting sensed angular velocity of the control device in at least one angular dimension;
processing the inputs to detect a strike action, as a peak in said angular velocity above a strike threshold; and
in response to detecting the hit action, outputting a percussion control signal to an audio synthesiser to cause the audio synthesiser to output an audio signal.

20. The method of claim 19, wherein the orientation sensor comprises a gyroscope and the hit action is detected from raw angular velocity measurements provided by the gyroscope.

21. The method of claim 19, wherein the hit action is detected from a current measurement angular velocity and two preceding measurements only.

22. The method of claim 19, wherein a sign of the peak is used to determine a sound selection parameter, whereby strike actions in different directions trigger different sounds.

23. The method of claim 22, wherein the gyroscope measures pitch and yaw angular velocity, wherein:
a positive peak in yaw angular velocity above a first strike threshold triggers a first sound,
a negative peak in yaw angular velocity below a second strike threshold triggers a second sound,
a positive peak in pitch angular velocity above the first or a third strike threshold triggers a third sound, and
a negative peak in pitch angular velocity above the second or a fourth strike threshold triggers a fourth sound.

24. (canceled)

25. (canceled)

26. An audio synthesizer control device for generating audio synthesizer control signals, the audio synthesizer control device comprising:
an elongated body comprising a handle portion lying along a longitudinal axis of the elongated body and an arm portion extending outwardly from the handle portion along the longitudinal axis, the elongated body supporting:
a multi-dimensional orientation sensor, located in or on in the arm portion, and configured to sense changes in orientation of the audio synthesizer control device in multiple angular dimensions; and
a computer coupled to the multi-dimensional orientation sensor and configured to process inputs from the multi-dimensional orientation sensor, and generate audio synthesizer control signals for controlling multiple audio signal characteristics based on sensed changes in orientation in the multiple angular dimensions.
